(19) United States
(12) Patent Application Publication
(10) Pub. No.: US 2018/0041404 A1
(43) Pub. Date: Feb. 8, 2018

(54) Virtual Broadband Communication Service Platform

(71) Applicant: Network Design Decisions, Inc., Somerset, NJ (US)

(72) Inventors: Gurdeep Singh, Highland Park, NJ (US); Ronald Grippo, Red Bank, NJ (US); John Landau, Morristown, NJ (US); David Dudley, Plymouth, CT (US)

(21) Appl. No.: 15/671,003

(22) Filed: Aug. 7, 2017

Related U.S. Application Data
(60) Provisional application No. 62/371,296, filed on Aug. 5, 2016.

(51) Int. Cl. H04L 12/24; H04W 84/04; H04W 92/02

(52) U.S. Cl. CPC H04L 41/50; H04W 92/02; H04W 84/04; G06F 9/5077

(57) ABSTRACT

A software platform enables the delivery of open access broadband networks by providing a set of capabilities for the physical infrastructure provider, network provider, service providers, and end customers. In particular, the platform virtualizes the underlying network to the service provider so that the service provider is presented with a view that represents the portion of the network that is allocated to them. The platform also provides the capability for customers to dynamically select services and service providers that are available through the network.

### CROSS-REFERENCE TO RELATED APPLICATION

This application claims the benefit of U.S. Provisional Application Ser. No. 62,371,296, filed Aug. 5, 2016, the contents of which are incorporated hereby reference in its entirety

### BACKGROUND

Broadband services have been historically provided to consumer and business customers by incumbent large telecom and cable providers who built and owned the infrastructure. Due to regulatory and historical precedent for most communities, the incumbent broadband service provider either does not have competition or the community is served by at most one other provider. These incumbent service providers are not investing in infrastructure due to other available investment opportunities and as a result are ignoring many communities.

Incumbent broadband service providers face capital outlays to build out high speed broadband networks to communities and/or purchase dark fiber to meet ever increasing throughput requirements. Incumbent providers have little incentive to upgrade aging infrastructure or deploy new infrastructure in less densely populated communities with poor broadband connectivity.

Some communities ignored by the broadband service providers have opted to build out their own broadband network; this has in some areas become a contentious political issue. Many of these community based networks are competing with existing service providers as these communities have chosen a path of becoming the Internet Service Provider themselves. As a result, these investments by communities are also driving large service providers to lobby for state legislation and regulatory bodies to block communities from building their own infrastructure. Federal rules have preempted these state laws arguing that the infrastructural needs of communities have not been adequately serviced by the market.

Communities that have opted to deploy their own municipal broadband face many significant challenges, including a very steep learning curve, high risks, competition from highly funded incumbents, and high capital costs.

One model that communities are using to mitigate some of these challenges is to provide an “open access broadband network” allowing multiple service providers to compete on a level playing field, lowering costs to subscribers and encouraging innovation. This would involve a municipality building a fiber optic network and making it available on a wholesale level allowing many tenants to offer services. The wholesale model provides infrastructure that benefits citizens of the community offering them more choices among services and a new revenue stream. Incumbents also benefit from the wholesale infrastructure allowing them to provide broadband offerings in geographies without providing infrastructure investment; creating a true competitive landscape.

Open access wholesale networks will open opportunities in the market for different businesses. Some of these opportunities are described in a report provided by the European Commission in “Guide to High-Speed Broadband Investment,” European Commission, Guide to High-Speed Broadband Investment, Release 1.1-22 October 2014. The report has defined a framework describing network architectures for providing broadband and possible business models arising from operating an “open access broadband network”.

The framework defines three layers of architecture for an open access network: physical infrastructure layer, network layer, and service layer; each are characterized by the different technical and economical features unique to each layer. From this framework characterization, three main business roles are described:
Physical infrastructure provider (PIP): owns and maintains the infrastructure;
Network provider (NP): operates (and typically owns) the active equipment;
Service provider (SP): delivers digital services and equipment as needed.

The premise is that broadband markets will evolve allowing different business models to arise to incorporate these roles in different ways providing “open access networks” as shown in FIG. 1. Three such business models are shown in FIG. 1. These business models can be contrasted to the vertically integrated closed networks provided by incumbent service providers, which is illustrated by the right-most business model in FIG. 1.

Opportunities will emerge businesses in each of the models presented not only for the roles identified but for software and systems to manage and operate each layer.

### SUMMARY

In accordance with one aspect of the subject matter described herein, a virtual broadband platform is provided which allows a plurality of service providers to offer services to customers over a common broadband access network. The platform includes a virtual broadband platform management component, a service provider management component and a subscriber management component. The virtual broadband platform management component is configured to (i) virtualize physical network resources of a broadband access network such that each of the network resources are selectively allocatable among the plurality of service providers as virtual network resources in response to requests received from the service providers and (ii) arbitrate and implement event requests from the service providers and the customers across the physical network resources of the access network, the event requests including requests to dynamically combine and decompose virtual network resources. The service provider management component is configured to (i) communicate request events from each of the plurality of service providers to the virtual broadband platform management component and (ii) allow each of the service providers to control the virtual network resources that they are each respectively allocated. The subscriber management component is configured to (i) communicate request events from the subscribers to the virtual broadband platform management component, at least one of the subscriber request events being a request to switch at least one service from a first of the service providers to a second of the service providers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture such as one or more computer-readable storage media. These and various other features will be apparent from a reading of the following Detailed Description and a review of the associated drawings.

### BRIEF DESCRIPTION OF THE DRAWINGS

FIG. 1 shows various examples of broadband provider business models.

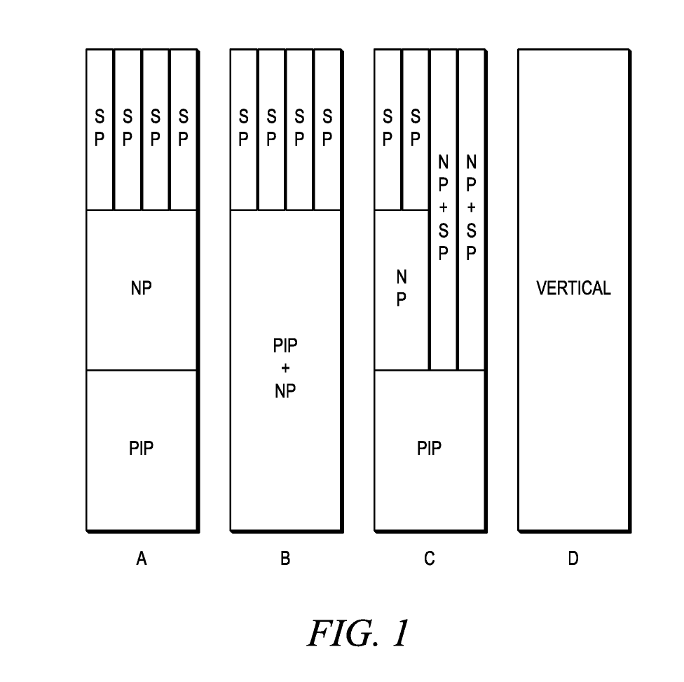

FIG. 2 shows one example of a broadband access network implemented as a passive optical network (PON).

FIG. 3 shows a functional block diagram of one example of a virtual broadband platform.

FIG. 4 shows one example of the view of a virtualized network that may be presented to a service provider.

FIG. 5 shows an example of a customer premises optical network unit (ONU) that decomposed into elemental virtual devices.

FIG. 6 shows an example of compound virtual devices.

FIG. 7 shows an example of decomposed and recombined virtual devices.

FIG. 8 shows an example of shared virtual devices associated with an Optical Line Terminal (OLT) line card.

FIG. 9 shows an example of the manner in the virtual broadband platform database may be partitioned.

FIG. 10 shows the data, feeds and users associated with the virtual broadband platform.

### DETAILED DESCRIPTION

### Introduction

As detailed below, a virtual broadband communications platform is described which enables a coherently managed, open access broadband network that can serve a variety of access customers, each contributing to network requirements. Access customers may include any of the following:
Residential Customers:
   Single family homes and multi-family premises.
Small and Medium Business Customers:
   Business in a single building, and multi-tenant building, and large business complexes with a number of buildings,
Large Enterprise Businesses:
   Business spread across multiple complexes locally and over a long distance with high speed connectivity requirements among locations.
Public Enterprise Facilities:
   Municipal Customers: township facilities, schools, and other municipal buildings,
Public Spaces:
   Public WIFI Neutral Hosted Hot Spots,
Wireless Providers:
   Backhaul for cellular towers, and
Incumbent Providers:
   Connectivity for legacy broadband access networks such as legacy DSL and Cable networks.

The open access broadband network enabled by the present invention provides a level playing field that opens up competition for customers by allowing for a wide variety of service providers to enter the local market. These providers may offer traditional broadband services. In addition, the network can open the path for innovation allowing these service provers to offer new types and variety of services to emerge.

Competition among Service Providers for the following traditional broad services can be expected:
High Speed Internet Access Services
Telephony Services
Broadcast and Cable TV Services
Security and alarm services
Private access networks
WIFI Hot Spots Services.

The opportunity for innovation may drive new services from both existing and new providers. A few of these include new services to consider are:
IoT Services
Over the Top (OTP) and SVOD Services
Smart Home Services
Smart City Services
   Utilities Management: Smart meter readers for power, water, gas companies. Power, water, and gas network monitoring, reporting, and control.
   Security: Public and private smart security services integrating video monitoring
   Traffic: Smart road monitoring with video monitoring of road conditions, smart traffic light monitoring, reporting, and control, smart street light monitoring and control
   Health:
E911 Services for Over The Top (OTP) VoIP telephony
Multiple bandwidth providers in the same home, allowing services providers targeted for parents, children, home based businesses, etc.
Wireless service provider backhaul to wireless towers. And as next generation wireless services are rolled out, the communities that are supported by such a platform will be able to realize them rapidly.

### Neutral Host Wholesale Physical Infrastructure Layer

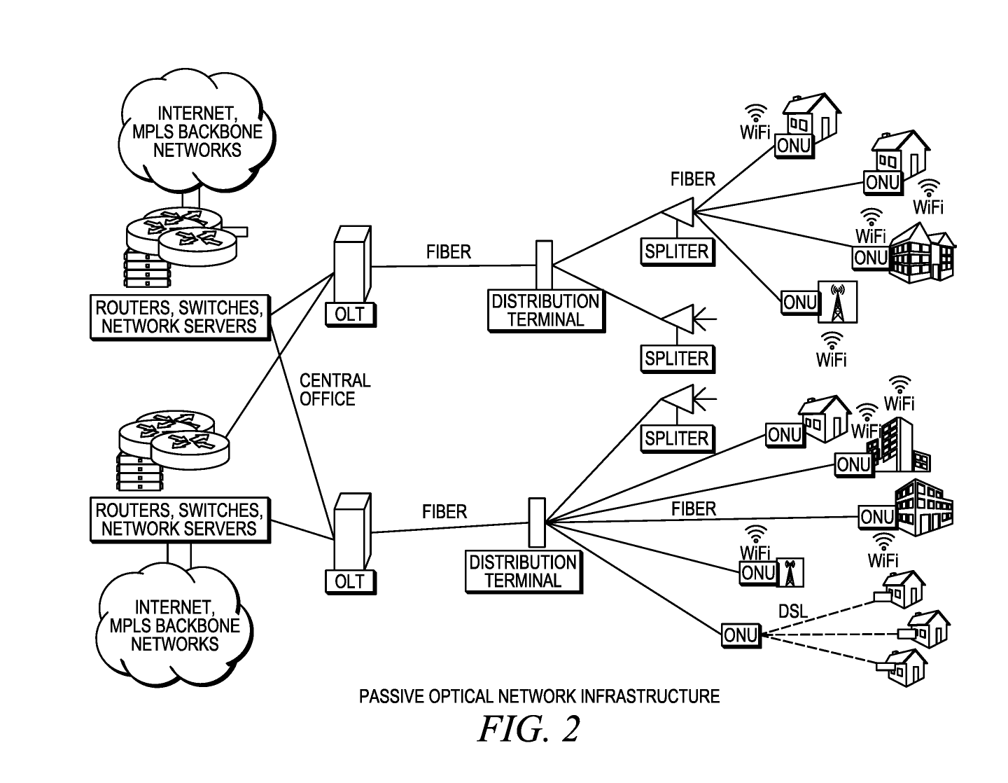

One example of an open access broadband network, built on a neutral host shared physical infrastructure layer, is shown in FIG. 2. In this particular example the open access broadband network is a passive optical network (PON) that includes unpowered components such as optical fiber, unpowered optical splitters, isolators, filters, distribution frames, fiber couplers, and so on. More specifically, in a PON network each node has a single output signal that is split into N copies that are sent to N different end users or fiber to the curb nodes (nodes that terminate the optical signal prior to reaching the end user—converting the signal to an electrical signal or wireless signal to send it to the end user). The PON in FIG. 2 includes upstream optical line terminals (OLTs), which may be located in a central office of the network service provider, and downstream optical network units (ONUs), which are service interfaces to end users or to legacy services such as DSL. Optical system nodes such as the illustrative distribution center may be located between the OLTs and ONUs. The distribution center may include optical components such as power splitters, wavelength splitters, or a combination of both power and wavelength splitters. The upstream OLTs are coupled to the downstream ONUs and any intermediate optical system nodes by optical fiber.

Upstream from the OLTs may be higher tiered networks such as metro networks, regional networks and backbone networks.

It should be noted that the physical infrastructure of the open access broadband network may include networks other than PONs. For example, the physical infrastructure may include legacy networks such as DSL networks.

The physical layer infrastructure provides a platform to evolve with technology advancement. As the technologies advance, specifically in optical electronics, higher speed bandwidth will be capable over the same fiber infrastructure. This will allow optical line termination (OLT) systems and optical network units (ONU), (i.e., the active network components), to be “easily replaced” allowing the Network Provider to offer higher bandwidth speeds to customers.

The physical access infrastructure layer provides the physical connectivity between the central office/Hub and customers.

The access infrastructure can be deployed typically as a point-to-point architecture, with individual fibers run between the Optical Line Termination (OLT) systems and Optical Network Unit/Termination (ONU/ONT) serving a customer or alternatively as a point-to-multipoint architecture where unpowered Fiber Optic Splitters are used to enable a single optical fiber to serve multiple ONU/ONT customers.

In addition, to optical technologies the physical access infrastructure may also include Wi-Fi and Ethernet mediums.

The physical layer is unaware of multiple service providers or tenants operating on it. Segregation and security of data traffic and bandwidth guarantees for a tenant is provided by upper the network layers.

The physical access infrastructure layer may bring connectivity to the following types of locations within the community:
Single family homes and multi-family buildings,
Small business building, multi-tenant buildings, and large business complexes,
Township facilities, schools, and other municipal buildings,
Public service providers: hospitals, police stations, fire stations, etc.
Public WIFI Neutral Hosted Hot Spots,
Cellular towers, and
Legacy broadband network segments such as legacy DSL and Cable networks.

Some types of customers (large businesses, hospitals, police stations, etc.) may have unique requirements at the physical layer. These requirements can include:
Redundant physical facilities
Dedicated physical facilities between locations
Multiple fiber strands for high bandwidth applications.

The physical backbone infrastructure layer provides the physical connectivity between the broadband backbone network and the physical access infrastructure.

The central offices/Hubs are built with reliability concerns in mind. There can be two (or more) locations designed into the Network to allow for continued operation if one of the locations becomes unavailable.

Access network aggregation devices, optical line termination systems, and Ethernet systems are deployed with connectivity to multiple facilities.

A central office/Hub will have multiple connections to the backbone to meet the reliability requirements. Typically each the connections are with different backbone access providers.

Connectivity to the Internet may be provided with a Tier 1 Internet Service Provider, directly and/or with other Internet Service Providers offering service on the network. Private connectivity can be provided several ways including enterprise networks over MPLS.

### Neutral Host Wholesale Network Layer

The wholesale network layer rides on top of the open access broadband network physical infrastructure consisting of the active (powered) network elements riding on top of the physical infrastructure.

The network layer allows multiple service providers or tenants to operate over the same physical infrastructure by providing the following services:

1. Data Traffic Segregation:
Tenant data partitioned and isolated within the network layer at the data link layer (Layer 2) using Virtual LAN or other technologies such as wave length division multiplexing, time division multiplexing to provide partitioning of the network for separate tenants.

2. Data Traffic Security
Tenant data is encrypted to ensure privacy between tenants and between customers.

3. Bandwidth Guaranteed Service
Network layer provides Service Level Agreements for network data traffic for each tenant. The network layer will utilize techniques typically as traffic shaping and policing to enforce specific bandwidth requirements specified by tenants.

4. Best Effort/Oversubscribed Service
The network layer allows for provisioning of oversubscription of capacity across services and service providers. When provisioned as such, the network provides a “best effort” to deliver every packet as quickly as it can, it makes no effort to treat any packet preferentially to any other packet, and the delivery of any given packet is not guaranteed.

The neutral hosted access network layer consists of the active elements of the network. These active elements include Optical Line Termination systems (OLT) at the central office/hub, Optical Network Unit/Termination (ONU/ONT) located at the customer premise, neutral hosted Wi-Fi access points, and Ethernet termination devices. These devices are provisioned with one or more unique VLAN(s) for each service provider and for each of the services the provider offers.

For example, a port on the ONU/ONT is provisioned to a specific service associated with a specific service provider. A customer accesses the service by connecting equipment (set top box, VoIP terminal adapter, data, etc.) to the specific port assigned. Traffic from the service provider over the access network is segregated from other service provider traffic and other customer traffic by virtue of the VLAN assigned to the specific service and customer.

The OLT and ONU devices are provisioned to encrypt the data traffic over a VLAN to ensure privacy of data traffic flow. On a PON network, OLT downstream signals are broadcast to all premises sharing multiple fibers split by an optical splitter. Encryption is thus also required to prevent eavesdropping of data.

Neutral hosted Wi-Fi access points offering Wi-Fi services on behalf of service providers are provisioned a Service Set Identifier (SSID) and VLAN for the specific service provider.

The neutral hosted backbone network layer consists of the active elements of the backbone network. These active elements include routers/switches at the central office to route traffic between OLTs and service provider networks.

The backbone network layer interconnects to the Internet over a Tier 1 internet service provider networks to allow for traffic to be routed over the Internet or interconnects directly with specific service providers.

The backbone network layer includes dedicated and share elements (routers and switches). Shared elements are provisioned per service provider using VLANS to enforce traffic segregation, security, and bandwidth policies as required by the service provider.

### VIRTUAL BROADBAND PLATFORM

### Overview

The Virtual Broadband Platform (VBB) described herein is a software platform that enables the delivery of open access broadband networks by providing a set of capabilities for the physical infrastructure provider, network provider, service providers, and end customers.

The Virtual Broadband Platform virtualizes the underlying network to the service provider. The service provider is presented with a view that represents the portion of the network that is allocated to them. The underlying network is modeled by a set of virtual network devices and a set of virtual network paths which are presented to the service provider. The service provider perceives complete management and control of the underlying network through these virtual network devices and virtual network paths. The service provider essentially manages and controls the network resources contained within their partition through the virtual network devices and virtual network paths.

The service provider's allocation and view of the underlying network changes over time as their customer base evolves. The provider's view of the network will dynamically expand or contract as the service provider gains or loses customers for their services.

The VBB includes a virtualized management layer that provides the following capabilities:
1. Aggregation of information from multiple network elements/element types and presenting them to service provider in a unified set of network elements.
2. Management of VLAN's configurations: assignment to services, QoS as applicable at the ONU/ONT, ONT, and routers.
3. Network management: alarms, traffic and management stats per tenant and overall network.
4. Segregation of CDR's for each service provider.
5. Trouble ticketing mechanism to engage with the “PIP” and the “NP” to communicate and drive SLA's to resolve customer issues and ensuring the delivery of a high quality customer experience.

The Virtual Broadband Platform provides the capability for customers to dynamically select services and service providers available through the network. The services and service providers are selected by the community and provisioned within the Virtual Broadband Platform serving the community. The platform provides web portals and applications for customers to dynamically add/delete/change services. Customers have the ability to subscribe to multiple Service Providers in the same premise (home or business) through the portal.

The Virtual Broadband Platform also provides tools and procedures to allow service providers to identify, qualify, and reach out to potential customers in marketing campaigns.

The platform incorporates and utilizes the following information to provide this capability: customer demographics, service availability/customer, customer equipment capabilities, network inventory, and contract relationships between customers and service providers.

### Illustrative Broadband Platform

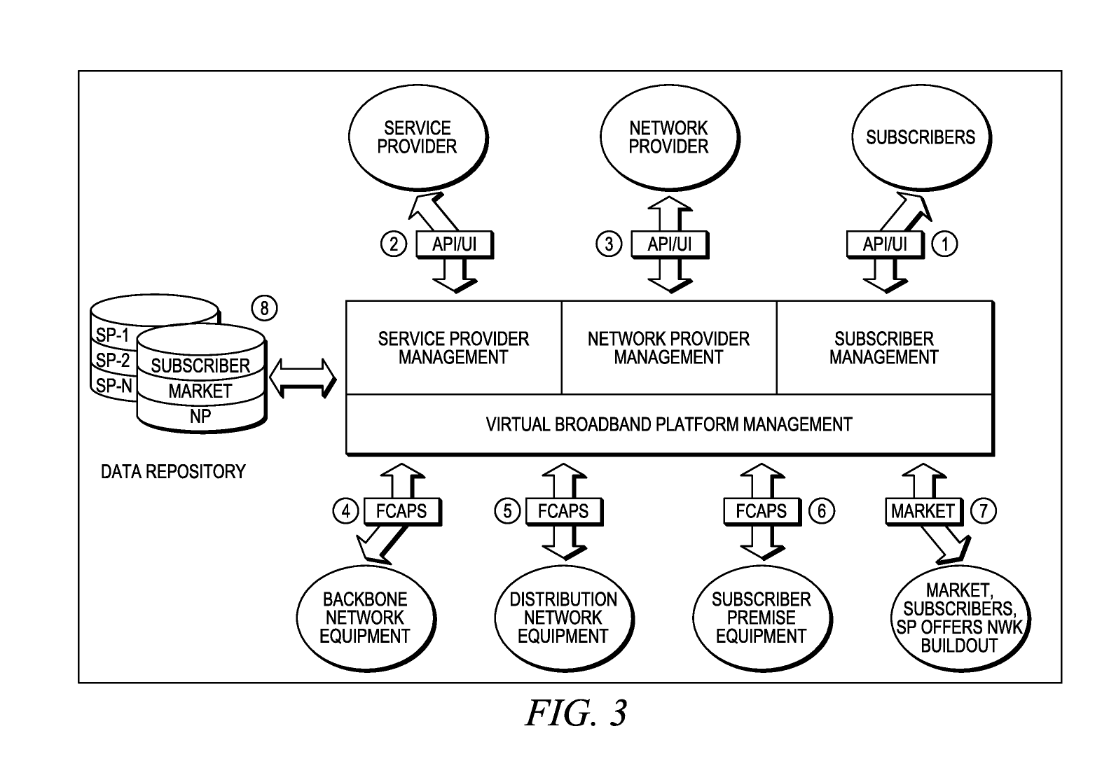

FIG. 3 shows a functional block diagram of one example of a Virtual Broadband Platform. The components of the platform include a Virtual Broadband Platform Management Component, a Service Provider Management Component, a Network Provider Management Component, and a Subscriber Management Component.

These Components manage resources across the Backbone Network, Distribution Network, and Subscriber Premises Equipment to deliver services to Subscribers on behalf of Service Providers. Network resources are virtualized and can be allocated and owned by a Service Provider allowing the provider to deliver services to Subscribers.

The management components interact with each other to implement a request events generated by a Service Provider, Network Provider, or Subscriber. The Virtual Broadband Platform Management Component analyzes the request event to determine the resources affected by the request event, to determine the owners of each of these resources, and to determine the Subscribers affected by these resources. The Virtual Broadband Platform Management Component orchestrates the implementation of required functions across each of the resources and then informs each of the affected owners of the resource state change and affected Subscribers determined during the request processing. Network Providers are also informed of the state change.

Resource conflicts are arbitrated by the Virtual Broadband Platform Management Component among the affected resource owners, Network Provider, and/or Subscribers, through the corresponding Management Component. As conflicts are resolved all parties affected by the conflict are informed.

Fault, Account, or Performance Events may originate from the Backbone Network, Distribution Network, and/or Subscriber Premise Equipment. Management Components interact with each other to process the event and take the appropriate action. The Virtual Broadband Platform Management Component analyzes the event to determine the resources affected by the request event, to determine the owners of each of these resources, and to determine the Subscribers affected by these resources. The Virtual Broadband Platform Management Component orchestrates the implementation of appropriate action across each of the resources and then informs each of the affected owners of the resource state change and affected Subscribers determined during the request processing. Network Providers are also informed of the state change.

Interactions between the Management components, detailing the orchestration and arbitration processes, are described below using a scenario where a subscriber places an order to add a service from Service Provider 1 and drop existing service from Service Provider 2.
1. The subscriber uses an Internet Browser to interact with interface 1 to access the Subscriber Management Component and obtain offers provided by service providers available on the platform.
2. The subscriber accesses the Subscriber Management Component to replace the service provided by Service Provider 2 with the service provided by Service Provider 1.
3. Subscriber Management Component issues a request event to the Virtual

Broadband Platform Component to trigger subscriber's requested change.
4. The Virtual Broadband Platform analyses event request. This process consists of:
a. Consult the Data Repository to determine the set of resources owned by Service Provider 1 to provide the current service to the subscriber.
b. Consult the Data Repository to determine the set of resources required to by Service Provider 2 to provide the requested service.
c. Analyze the resulting set of resources to determine set of resources in conflict.
d. Analyze the request to determine the operations required for each resource.
e. Analyze all resources and required operations on those resources to determine the implementation sequence.
5. The Virtual Broadband Platform resolves conflicts among the resources in conflict by requesting the Service Provider Management Component.
6. The Service Provider Management Component resolves the conflict as determined by the service provider agreement with subscriber. One of the following actions may result:
a. Allow resource change to occur.
b. Prevent resource change to occur.
c. Inform Service Provider and await decision by Service Provider.
7. Once all resource conflicts have been resolved, the Service Provider Management Component informs the Virtual Broadband Management Component.
8. The Virtual Broadband Management Component implements the request. For each resource, in the order specified in the implementation sequence, the Virtual Broadband Management Component implements the following steps:
a. Inform the resource owner of the update, through the Service Provider Management Component.
b. Inform the Subscriber of the update, through the Subscriber Management Component
c. Inform the Network Provider of the update, through the Network Provider Management Component.
d. Implement by updating the resource as previously determine during the analysis step.
9. Once all resource updates have been completed:
a. Inform the resource owner of request completion, through the Service Provider Management Component.
b. Inform the Subscriber of request completion, through the Subscriber Management Component
c. Inform the Network Provider of request completion, through the Network Provider Management Component.

### Network Virtualization

The Virtual Broadband Platform virtualizes the underlying network presenting to the service provider a view that represents the portion of the network allocated to them. The provider's view of the network will dynamically expand or contract as customers are added or removed to/from the provider's services.

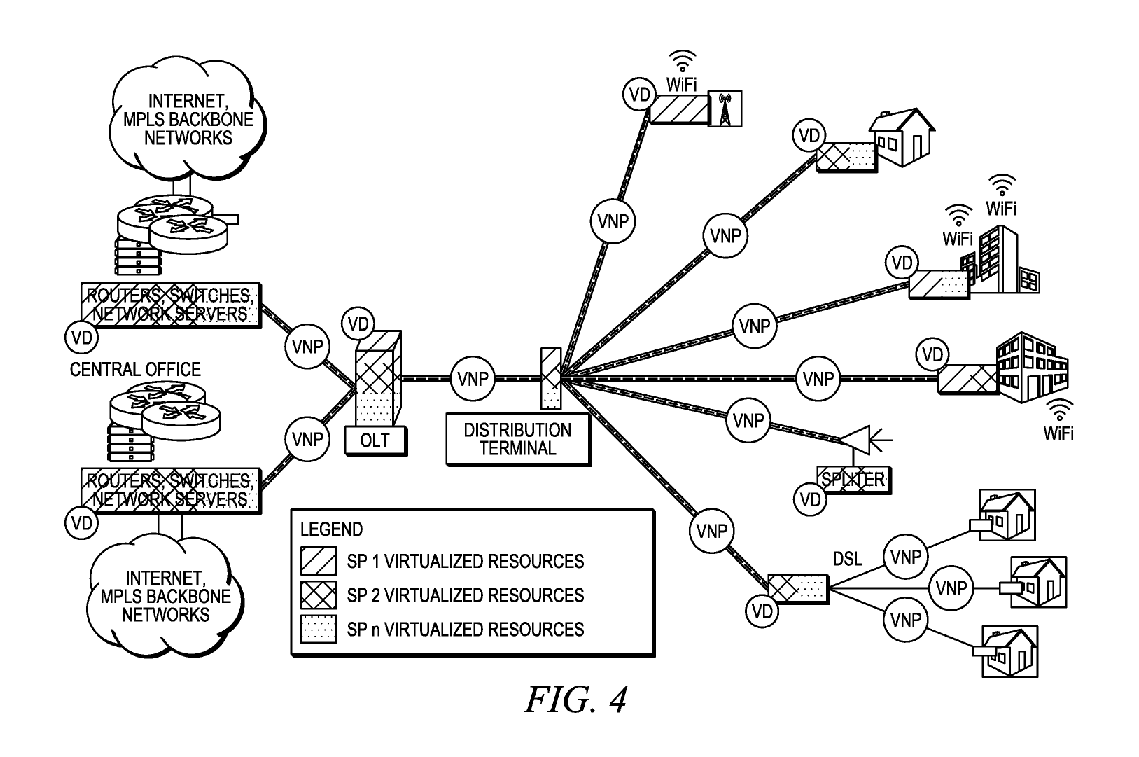

The platform decomposes physical devices into either a set of dedicated elements, separately partitioned by the physical device, or into a set of shared elements, each represented as a virtual device. The example network diagram, shown in FIG. 4, indicates Virtual Devices with “VD” markers. Dedicated Virtual devices can be independently allocated to Service Providers while shared virtual devices support multiple service providers and are allocated to Service Providers based on how virtual devices impact services provided by the Service Provider.

A Virtual Network Path represents the network connectivity between two virtual network devices. These paths present to the service provider a view that represents the interconnection of the network allocated to them. FIG. 4 indicates Virtual Network Paths with “VNP” markers.

Virtual devices derived from customer premise equipment are examples of dedicated virtual devices. Virtual devices derived from Optical Line Termination Devices are examples of shared virtual devices.

The Virtual Broadband Platform provides a view of the network to the service provider as collection of dedicated virtual devices, shared virtual devices, and virtual network paths that have been allocated to them. The collection of virtual devices and virtual network paths, presented by the Virtual Broadband Platform, allows the Service Provider to perceive complete management and control of the underlying network. The platform arbitrates the management and control functions but essentially provides the mechanisms for the Service Provider to manage and control the network resources affecting their customers as if it is part of their owned single-tenant network, using their own systems and processes.

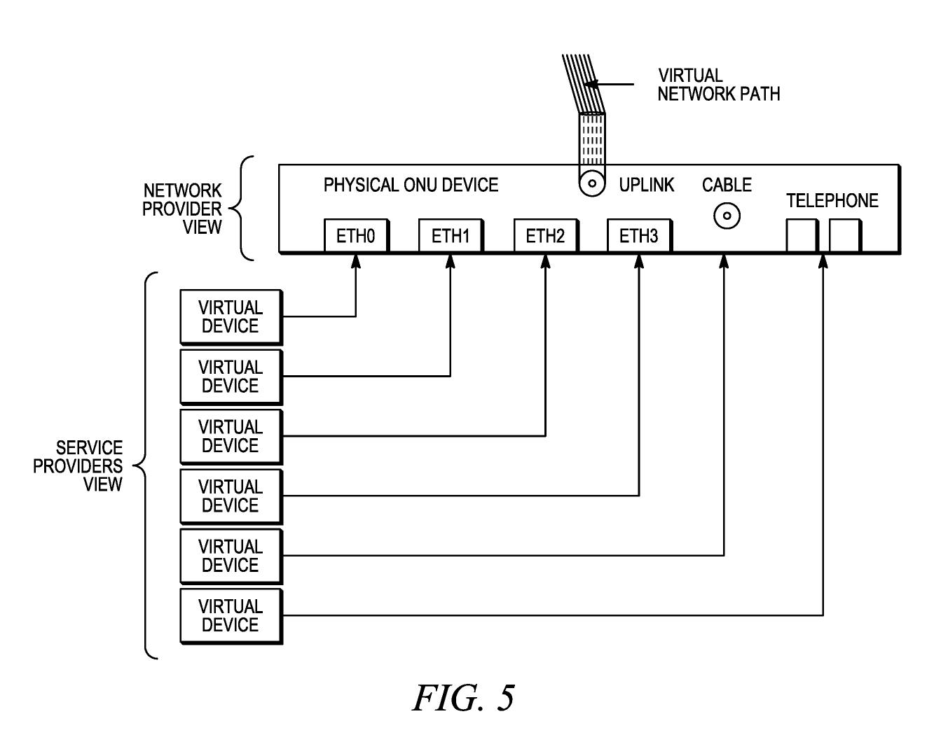

FIG. 5 shows an example of a Customer Premises ONU device that is decomposed into elemental virtual devices.

The network provider maintains complete management and control of the entire device while Service Providers maintains the control over the virtual devices that are allocated to each of them.

Multiple virtual devices may be combined by the platform into a single virtual device, called a compound virtual device. A compound virtual device may be combined from any number of elemental virtual devices up to all elemental virtual devices derived from a physical device. Compound virtual devices can be independently allocated to Service Providers while elemental virtual devices may be either allocated to a service provider or part of a compound virtual device.

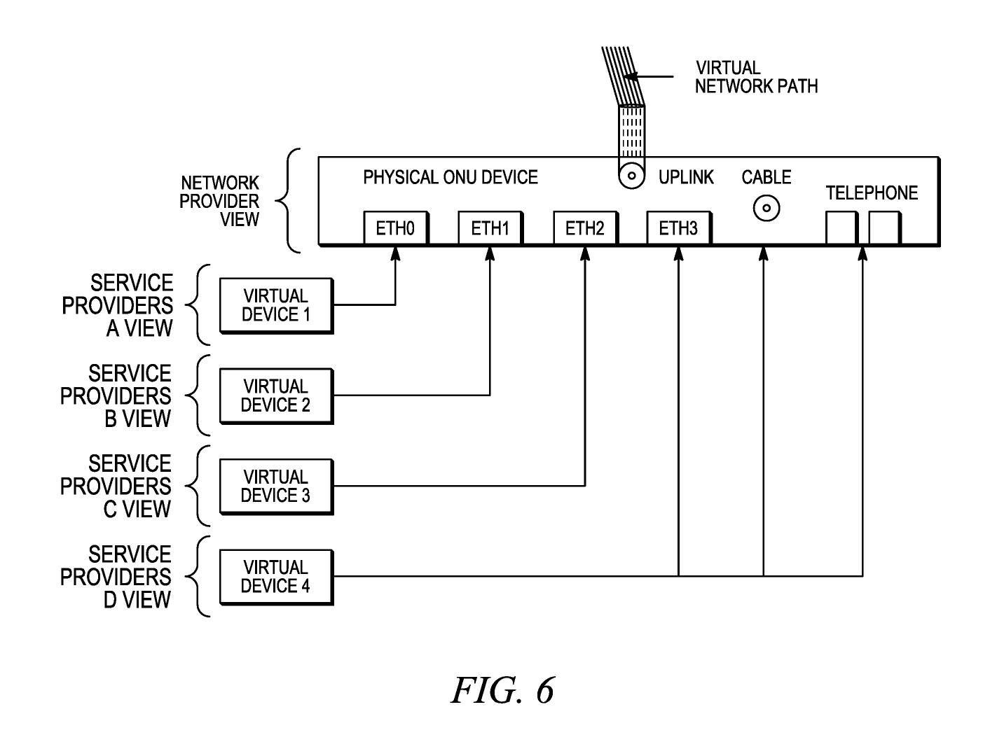

FIG. 6 depicts an example of a compound virtual device, Virtual Device #4. In this example, an Ethernet interface, digital Cable/TV interface, and the telephony interfaces are combined into a single compound virtual interface. This compound virtual device would allow a Service provider to offer Triple Play Service (Internet, TV, and Telephony services) to a customer.

Elemental virtual interfaces may be dynamically combined, decomposed, and recombined based on requests from services providers and end customers. The Virtual Broadband Platform arbitrates these requests under the control of the Network Provider.

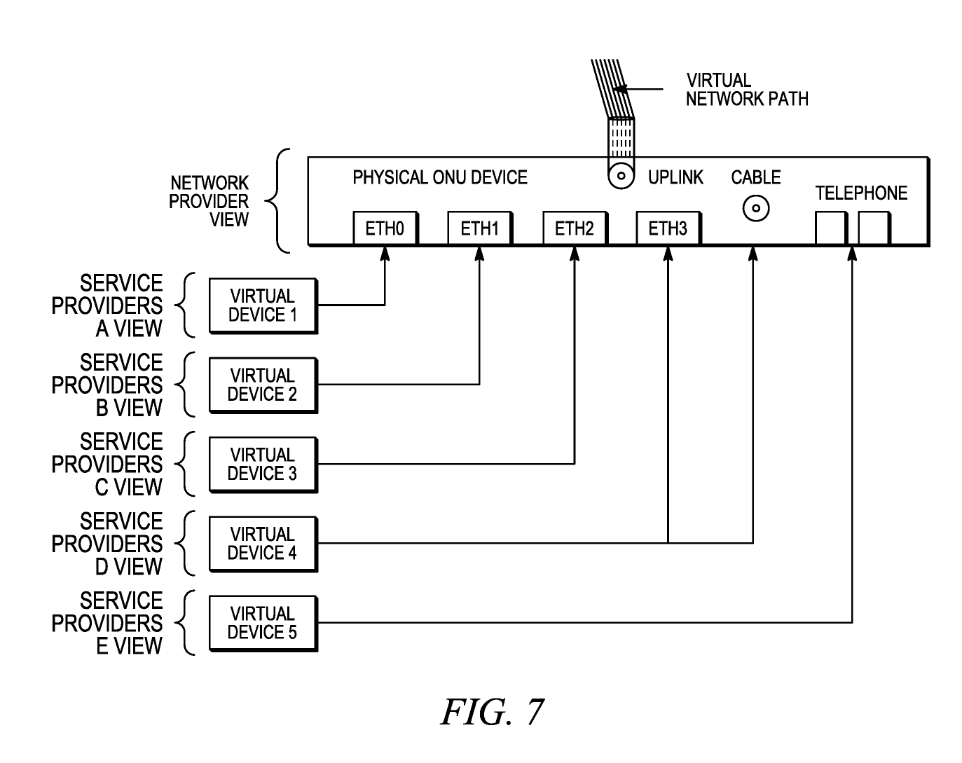

For example, Service Provider D's Triple Play Customer interacts with the Subscriber Management Component APIs to terminate telephony services with Service Provider D and engages with Telephony Service Provider E. As shown in FIG. 7, the platform would dynamically decompose Virtual Device 4 into its elemental virtual devices, (Ethernet interface, digital Cable/TV interface, and telephony interfaces) and recompose Virtual Device 4 with the Ethernet interface and digital Cable/TV interface. Finally, the Telephony interface, Virtual Device 5, would be allocated to Service Provider E.

Shared virtual devices are elements in the network where traffic from multiple service providers is handled. A shared virtual device is allocated to a set of Service Providers where operation of this shared virtual device impacts customers of these Service Providers.

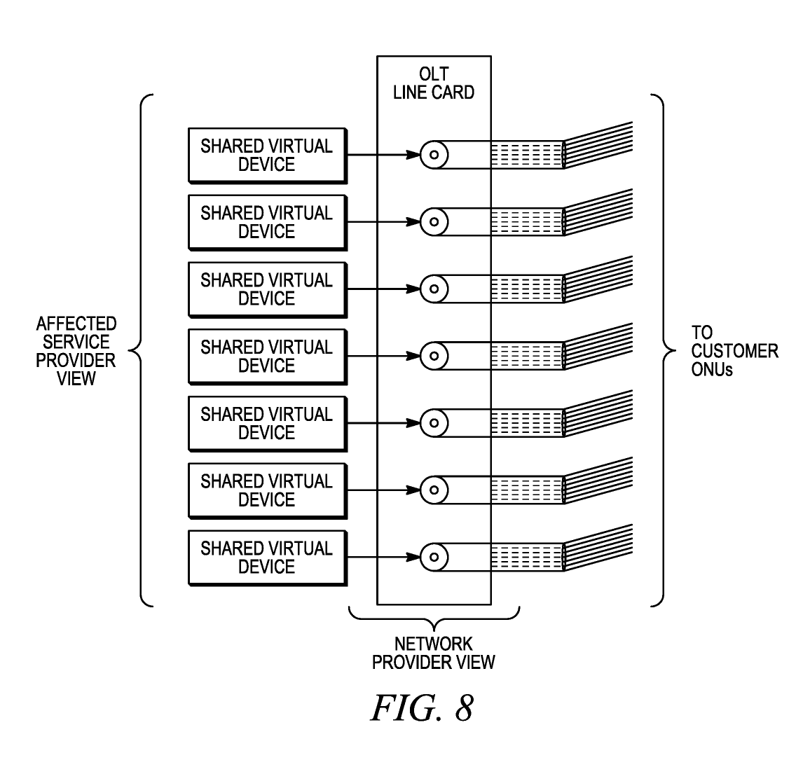

FIG. 8 shows an example of a physical Line Card in an Optical Line Termination. Each port terminates a fiber connecting to one or more subscriber premises. Each fiber may support many services provided by a number of Service Providers. The port on OLT Line Card will be represented by a Shared Virtual Device allocated to each Service Provider providing services over through the port.

The network provider maintains complete management and control of the entire device while Service Providers maintains the control over the virtual devices that are allocated to each of them.

Each shared virtual device is perceived to be managed and controlled by the service provider. For example, events on the shared virtual device will be reported to all service providers allocated to the device.

Shared virtual devices may be dynamically allocated/unallocated to Service Providers as services that are associated with the device are added or removed based on requests from services providers and end customers. The Virtual Broadband Platform arbitrates these requests under the control of the Network Provider.

Each Virtual Network Path has a virtual dedicated path through the network enforced by Layer 2 VLANs. The Virtual Network Path defines traffic shaping, policy, and policing rules to provide bandwidth guarantees and delivery guarantees.

Virtual Devices and Virtual Network Paths transition through a number of states as a result of the provisioning activities performed by the Virtual Broadband Platform Interface.

States of a Virtual Device/Path:
Un Allocated:

The virtual device/path is not assigned to any service provider

Allocated:
The virtual device/path is allocated to one or more service providers.
Dedicated Virtual Devices can be allocated to one service provider. Shared Virtual Devices can be allocated to many service providers.

Activated:
The virtual device/path has been put into service for a subscriber. Dedicated Virtual Devices become active once service is provided to the customer by the service provider through that device. A Shared Virtual Device becomes active for a given service provider once that device is provisioned to begin carrying traffic for customers of that service provider.

Reserved
A virtual device/path may be reserved for a service provider. A virtual device reserved for a given service provider may only be activated by that service provider. The service provider may have contractual relationships providing exclusive rights to specific virtual devices.

Provisioning actions, initiated by APIs interfacing with the Management Components, trigger state transitions and changes to virtual device characteristics and attributes. For example, provisioning multiple new services for a specific customer may combine multiple elemental virtual devices into a single compound virtual device as these devices transition from the un-allocated to the allocated state. A provisioning change to existing customer may cause existing compound virtual devices to be re-synthesized.

Service providers initiate provisioning requests, using the Service Management Component APIs, to trigger add, change, and remove services for their customers through the Virtual Broadband Platform (VBB). As these requests are processed, the VBB provides the following capabilities:
Identifies the set of Virtual Devices and Virtual Network Paths required to implement the request.
Identifies the set of physical devices and network paths hosting the identified Virtual Devices and Virtual Network Paths.
Identifies the set of provisioning steps required on each of the physical devices to build out the required virtual network changes required for the request.
Ensures that service provider is authorized to offer services using the identified physical devices/paths and virtual devices/paths.
Ensures that the required resources and capacities are available on identified physical devices/paths and virtual devices/paths.
Implements the request by performing the provisioning steps on each of the physical devices to build out the virtual network changes specified for the request.

### Virtualized Management Layer

In one embodiment, the Virtual Broadband Platform provisioning functions virtualizes a network management model such as the FCAPS model that is presented to Service Providers. FCAPs model is the ISO Telecommunications Management Network model and framework for network management. It defines fault, configuration, accounting, performance, and security functions expected by network providers. Of course, in alternative embodiments other network management models may be used instead.

By integrating with the Virtual Broadband Platform's Virtualized FCAPS model, the service provider is presented with management control over their portion of the network. Each of the different functions that are virtualized are discussed below.

In regard to fault management, the Virtual Broadband Platform receives alarms from the network elements detecting faults that occur in the network. The platform may receive multiple alarms in response to a specific fault in the network. These alarms may be sent to the Virtual Broadband Platform directly from network elements detecting the fault or may be sent indirectly through an element management system fronting network elements. An element management system may aggregate and then forward on to the Virtual Broadband Platform based on type, value, severity, and frequency.

Alarms received by the Virtual Broadband Platform are analyzed to determine the service providers and services affected. The platform identifies the virtual network devices and virtual network paths affected by the alarm. The platform then generates alarms based on the set of virtual network devices and virtual network paths to each of the service providers for each of the services affected by the fault.

In regard to configuration management, service providers send change requests to the Virtual Broadband Platform to add/change/delete their view of the network. These change requests are directed at the virtual network presented to the service provider. The service provider's request may include a request to add a new virtual device, a request to delete a new virtual device, or a request to change attributes of a new virtual device. The resulting view of the service provider's view of the network may expand or contract as a result of virtual devices/paths being added or removed.

The incoming requests are analyzed to determine the network elements affected, including ONU/ONT, OLT, and network routers/switches; and the configuration attributes for each of these affected elements. The configuration attributes include allocation of resources on the element to services, VLAN parameters, quality of service (QoS) policy parameters, etc.

The platform implements the change request by sending appropriate network element commands, containing the determined parameters/attributes, either directly to network devices or indirectly to network devices by element management systems. The platform integrates with the element's native network management interface(s) utilizing TR-069 agents, element management systems, or other intermediary software provided by the elements manufacture to configure the underlying network to achieve the required state of the network.

Multiple types of change requests are defined for service providers allowing them to create the services offered at the given demand point. For example, a layer 2 VPN can be setup and control given to the service provider for a business fiber drop; such service may not be allowed to a residence.

The platform allows the service provider to access their network view using this information the service provider may issue requests to expand or contract the network. These requests may result in a physical network built-out (for example, fiber needs to be extended to the property).

The platform provides an application to manage the build-out project. The application provides a mechanism to allow the Service Provider to interact and commit to its customers. A timeline and service level agreement for the build-out project is provided to the service provider by the application.

The application bases the build-out plan on guidelines provided by the network and physical infrastructure providers. The plan may include tasks for construction, installation, and provisioning to complete the build-out. The network and physical infrastructure providers' use the application to manage services provided by other third party providers (construction companies, engineering management etc.) and to provide status updates on the project's progress allowing the service provider to be kept informed on the progress of the build-out project.

In regard to the accounting function, the Virtual Broadband Platform tracks network utilization information with the focus on the ability for Service Providers to be able to individually bill its customers (i.e. residential subscribers, businesses, and other entities). Additionally, the platform tracks network utilization information to allow the network provider to bill each service provider.

Network utilization information, required to allow Service Providers bill customers, is stored in data records called Charging Detail Records (CDRs). The platform maintains CDR files separately for each Service Provider and provides a mechanism to transfer these records to each Service Provider. The set of CDRs given to a specific Service Provider include network utilization information only for their customers.

In regard to performance management, the Virtual Broadband Platform also tracks network utilization information, with the focus ensuring that network performance remains at acceptable levels. Performance data is used to determine the efficiency of the current network by monitoring throughput, network response times, packet loss rates, link utilization, percentage utilization, error rates, etc.

Performance management data is provided to Service Providers to provide the Service Provider with a view of the performance characteristics of their view of the network. The platform collects the performance data for all network elements, utilizing industry standard protocols (e.g. SNMP) by the platform from each of the network elements. This data is analyzed based on the set of Virtual Network Devices and Virtual Network Paths associated with a given Service Provider. The resulting data is made available to the Service Provider.

The platform supports industry standard procedures, such as FTP access to performance data, allowing Service Providers access to the resulting data associated with the Virtual Network Devices and Virtual Network Paths in their view of the network.

In regard to security, the Virtual Broadband Platform provides security management functions to control access to assets in the network. The platform provides full access to network elements by the network provider and provides limited access to network elements through Virtual Network devices for the Service Provider. The Service Provider is restricted from performing actions that might affect customers of other Service Providers.

The platform gathers security-related information and analyzes it regularly: Security-related information includes network authentication events, authorization events, and auditing of these events to ensure that both authorized internal and external users access appropriate network resources.

The platform records configuration and maintenance commands issued by network provider technicians and the platform itself, and results from each command issued against each network element. The platform provides reports from this data to network provider personnel for auditing purposes.

The platform also records configuration and maintenance commands issued by Service Provider technicians, and results from each command issued against each Virtual Network Device. The platform provides reports from this data to network provider personnel and Service Provider personnel for auditing purposes.

Physical security of the platform and all shared network elements is a vital requirement. The platform manages list of limited set of individuals who may access to the physical equipment. Service providers, with the necessary agreements with the physical infrastructure provider, may be provisioned on the security list and given access to the underlying network.

A mechanism may be provided such that at initial setup, each Service Provider will provided two VPN tunnels with the platform. One VPN tunnels is utilized for communicating alarm and network events, keeping the Service Provider informed in real-time about the state of the network and providing them with the ability to react and reach out to their customers in a timely manner.

The second link allows the Service Provider to access a Web Portal providing other information—such as configuration requests, network inventory, status, performance management data, and accounting data.

In regard to diagnostics, reset and maintenance functions, the Virtual Broadband Platform coordinates diagnostic and management access to shared network elements control access between Service Providers and the Network provider.

Network provider's personnel (e.g., technicians) require full access to all network elements to diagnose equipment, links, and ports. Any command (e.g. link reset) which may cause an impact on a network element or link may impact service provided to customers as well as to service providers. At a minimum, the platform will inform/warn the Network provider technician concerning the impact of the impending action. The platform may require prior agreement from the service provider before continuing with the specific action. Each command will be classified with an access policy enforced by the platform from minor impact to severe impact. These access policies prescribe the required authorization steps to be followed.

As an example, a minor impact policy might be applied to a port reset command directed toward a port on a residential customers ONT. This command will impact a single customer who may see a momentary loss of service. In this case, the service provider will be informed via an alarm that such a command was performed. Such information will allow the service provider to communicate with their customer with full knowledge of the underlying activity in the network.

As an example, a severe impact policy might be applied to a software upgrade command directed at a backbone network router resident in the central office. This command may impact many customers and many service providers. In this case, permission from the service providers may be required so that the service providers may communicate with their customers with full knowledge of the underlying activity in the network.

To aid in planned maintenance activities, the platform will provide a facility for the network provider to schedule planned maintenance windows and obtain authorization of these maintenance windows from all Service Providers.

Service provider personnel (e.g., technicians) are provided limited access to network assets. Service providers are allowed a “read-only” access to limited information concerning Shared Virtual Devices. The Service Provider will be provided data that does not disclose information concerning other Service Providers or their customers. Service provider technicians will need to escalate certain requests to Network Provider technicians, for example, to perform a write or reset command of the device.

Service providers are allowed “full” access to Dedicated Virtual Devices. A Dedicated Virtual Device, by definition, provides service only for a customer of this service provider. The service provider may execute commands associated with a Dedicated Virtual Device without impacting other customers, for example, to reset a Dedicated Virtual Device's port.

In regard to trouble management, the platform provides a mechanism for trouble ticket exchange or Electronic Bonding. This allows the service providers to issue trouble tickets and get their status by electronic query. Trouble management can be for the network provider. The network provider in turn can further refer the trouble to the physical infrastructure provider. The platforms trouble ticket mechanism allows the physical infrastructure provider, the network infrastructure provider, and the service provider to communicate and drive SLA's for resolutions needed to deliver quality customer experience.

The trouble ticketing exchange provides the logic to link trouble tickets involving Shared Virtual Devices across each Service Provider allocated to these Shared Virtual Devices allowing the Network Provider to respond to all affected Service Providers consistently.

### Dynamic Selection of Services and Service Providers

In one aspect, the Virtual Broadband Platform may provide the capability for customers to dynamically select from a set of services and service providers available from the network. These choices are selected by the community and provisioned within the Virtual Broadband Platform serving the community.

The platform provides web portals and applications for customers to dynamically add/delete/change services. The portal presents offers from service providers based on tailored attributes and demographics for the specific customer viewing the portal.

Customers may select these offers and dynamically add/change/delete services on demand and may subscribe to services from multiple Service Providers in the same premise (home or business) through the portal.

Customer requests flow thru the Virtual Broadband Platform to authorize and coordinate these transactions across the affected service providers automatically. Changes are automatically directed to the appropriate affected service providers' platform where the change request is validated and accepted. The platform coordinates approval request, approval acknowledgement, and notifications between customer, affected service providers, and network providers concerning the change.

The network model provided by Virtual Network Devices allows customers to have the ability to subscribe to multiple Service providers from the same device located on premise (home or business). Service providers can tailor their services to cater to specific needs and demographics (i.e. Internet for Teens, Internet for Children, Internet w/OoS for Business/Enterprise).

### Subscriber Identification and Acquisition

In one aspect, the Virtual Broadband Platform may provide tools and procedures to allow service providers to identify, qualify, and reach out to potential customers in marketing campaigns.

The platform incorporates and utilizes the following information to determine this information: customer demographics, service availability/customer, customer equipment capabilities, and customer/service provider contractual relationships.

The Virtual Broadband Platform provides tools and procedures to allow to service providers to identify, qualify, and reach out to potential customers in marketing campaigns incorporating and utilizing the following information to provide this capability:

Customer Demographics:
Customer demographic data includes information on all the potential customers in the community. This information includes type of customer (Residential, Business, etc.), location, property taxes, property valuation, length of residency, etc.

Service Availability Per Customer:
Service availability data includes information on potential customers who are currently eligible for service. Service availability data also include information on when additional potential customers will become eligible for service based overall neighborhood deployment plans.

Customer Equipment Capabilities:
Equipment data includes information on the installed customer base, specifically the type of ONU/ONT, the number, type, and availability of ports on the unit.

Customer/Service Provider Contractual Relationships:
Customer/Service Provider contractual information is utilized to identify available customers (or those reaching the end of a lock-up period). The platform maintains information about customers contract status and contract end dates. This information allows the platform to provide a facility to allow other Service Providers market to these customers. The contract data will be provided by customers themselves indicating that they are “in” the market for new services or service providers.

### Virtual Broadband Platform Data Management

In one aspect, the Virtual Broadband Platform data management design may ensure isolation of data between Service Providers and provide the information to coordinate interactions between Service Providers, Network Provider, and Subscribers.

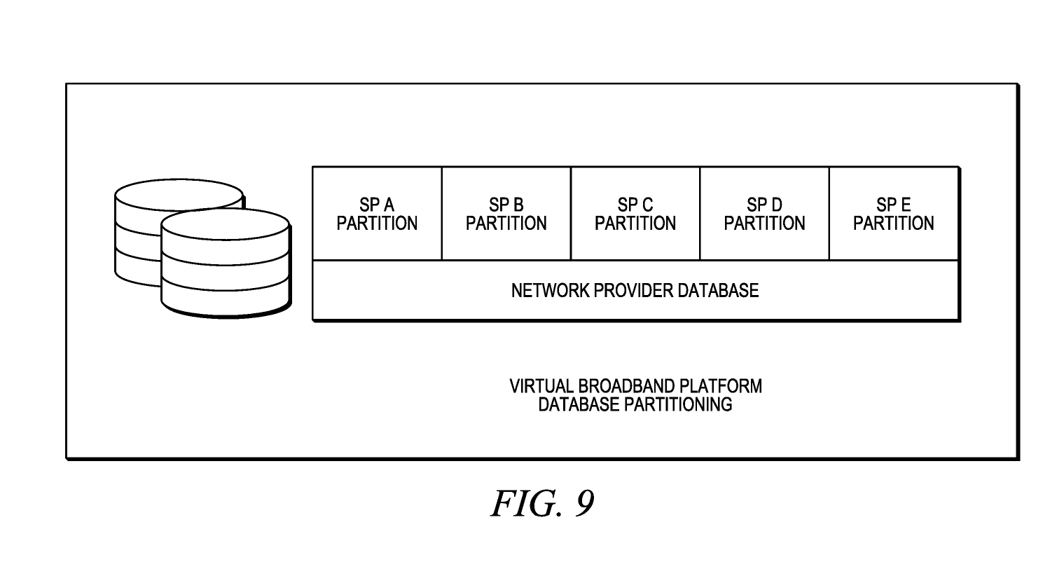

The Virtual Broadband Platform partitions Service Provider data to ensure that the data is isolated and only made available to the specific Service Provider. Data partitioning is shown in FIG. 9. The Service Provider access interface, implemented by the Virtual Broadband Platform, is given access rights to a specific partition ensuring secure access to only this specific partition.

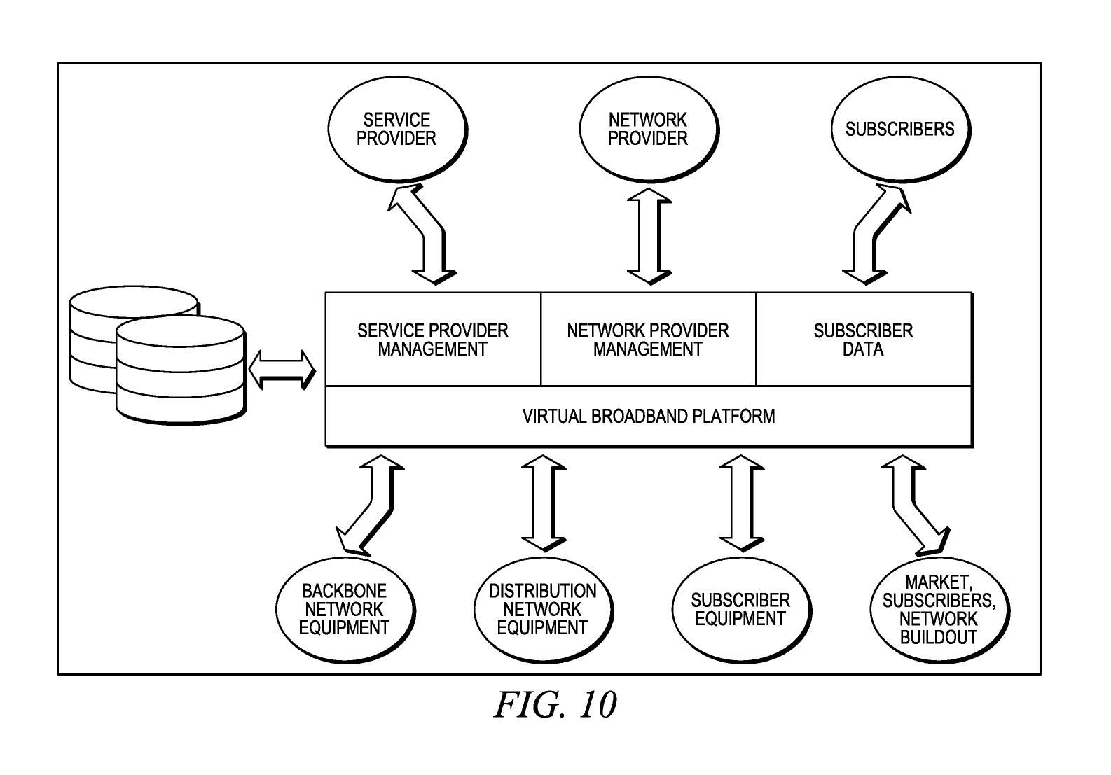

Examples of the Virtual Broadband Platform data, feeds, and users is shown in FIG. 10. The Platform maintains a series of feeds from the backbone network, distribution network, and subscriber equipment. The platform support feeds updated in real-time such as alarms and status updates from equipment and batch periodic update such as market demographics.

Data from feeds include configuration, alarms, events, status, performance data, location, and allocation between service providers. The platform may also maintain market demographics data, subscriber data, and network build out data.

The Virtual Broadband platform support portal interfaces for Service Providers, Network Providers, and Subscribers. Portal interfaces allow these users to update and view their data partitions. Real-time interfaces are provided to Service Providers and Network Providers; real-time updates provide network alarms and status data.

### Illustrative Computing Environment

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Also, it is noted that some embodiments have been described as a process which is depicted as a flow diagram or functional block diagram. Although each may describe the operations as a sequential process, many of the operations can be performed in parallel or concurrently. In addition, the order of the operations may be rearranged. A process may have additional steps not included in the figure.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . .), optical disks (e.g., compact disk (CD), digital versatile disk (DVD) . . . ), smart cards, and flash memory devices (e.g., card, stick, key drive . . . ). However, computer readable storage media do not include transitory forms of storage such as propagating signals, for example. Of course, those skilled in the art will recognize many modifications may be made to this configuration without departing from the scope or spirit of the claimed subject matter.

Moreover, as used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

1. A virtual broadband platform for allowing a plurality of service providers to offer services to customers over a common broadband access network, comprising:
a virtual broadband platform management component configured to (i) virtualize physical network resources of a broadband access network such that each of the network resources are selectively allocatable among the plurality of service providers as virtual network resources in response to requests received from the service providers and (ii) arbitrate and implement event requests from the service providers and the customers across the physical network resources of the access network, the event requests including requests to dynamically combine and decompose virtual network resources;
a service provider management component configured to (i) communicate request events from each of the plurality of service providers to the virtual broadband platform management component and (ii) allow each of the service providers to control the virtual network resources that they are each respectively allocated; and
a subscriber management component configured to (i) communicate request events from the subscribers to the virtual broadband platform management component, at least one of the subscriber request events being a request to switch at least one service from a first of the service providers to a second of the service providers.

2. The virtual broadband platform of claim 1, wherein the virtual broadband platform management component is further configured to receive network events from one or more of the physical network resources and determine one or more of the virtual network resources corresponding thereto.

3. The virtual broadband platform of claim 2, further comprising notifying one or more of the service providers who have been allocated the one or more of the virtual network resources from which the network events were received.

4. The virtual broadband platform of claim 2, wherein the network events are selected from the group consisting of fault and performance indicator events.

5. The virtual broadband platform of claim 1, wherein the broadband access network includes a passive optical network (PON).
